(19) United States
(12) Patent Application Publication
(10) Pub. No.: US 2015/0341846 A1
(43) Pub. Date: Nov. 26, 2015

(54) Targeted PLMN Search

(71) Applicant: Apple Inc., Cupertino, CA (US)

(72) Inventors: Jianxiong Shi, Dublin, CA (US); Qin Zhang, Mountain View, CA (US)

(73) Assignee: Apple Inc., Cupertino, CA (US)

(21) Appl. No.: 14/282,772

(22) Filed: May 20, 2014

(51) Int. Cl. H04W 48/16; H04W 64/00

(52) U.S. Cl. CPC H04W 48/16; H04W 64/00; H04W 48/18

(57) ABSTRACT

Targeted public land mobile network (PLMN) search by a wireless user equipment (UE) device. A PLMN search may be initiated at the UE. It may be determined whether PLMN search targeting information is available. A targeted PLMN search may be performed if PLMN search targeting information is available. Targeting the PLMN search may include reducing the number of frequencies or frequency bands searched as part of the PLMN search.

### FIELD

The present application relates to wireless devices, and more particularly to a system and method for wireless devices to perform a targeted public land mobile network search.

### DESCRIPTION OF THE RELATED ART

Wireless communication systems are rapidly growing in usage. Additionally, there exist numerous different wireless communication technologies and standards. Some examples of wireless communication standards include GSM, UMTS (WCDMA, TDS-CDMA), LTE, LTE Advanced (LTE-A), 3GPP2 CDMA2000 (e.g., 1xRTT, 1xEV-DO, HRPD, eHRPD), IEEE 802.11 (WLAN or Wi-Fi), IEEE 802.16 (WiMAX), Bluetooth, and others.

In some scenarios, as part of its wireless communication functionality, a wireless device may search various radio frequency bands for wireless communication networks. However, as an increasing number of wireless communication technologies are being deployed on an increasing number of frequency bands, this process tends to become more challenging and time- and power-consuming.

### SUMMARY

Embodiments are presented herein of methods for wireless devices to perform public land mobile network (PLMN) searches, such as manual PLMN searches, in a targeted manner, and of devices configured to implement the methods.

According to the techniques described herein, a wireless device which has initiated a PLMN search may target or narrow its PLMN search (e.g., rather than perform an all-band, all-radio access technology (RAT) search) in one or more of a variety of possible ways.

As one possible mechanism for targeting the PLMN search, the wireless device may limit or narrow the scope of the search to a set of frequencies or frequency bands specific to a particular location (e.g., country) in which the wireless device is located. For example, only frequencies deployed by carriers which operate in a particular country in which the wireless device is operating may be searched. As another example, only the bands and RATs which are known or expected to be deployed in that country may be searched.

Note that if the wireless device is in a border area between or near to another region or country, the search may also encompass frequencies/bands/RATs deployed in each other nearby region/country.

As a further possibility, the wireless device may be capable of aborting or skipping further search once all target PLMNs have been found.

Additionally, if desired, the search may be prioritized such that one or more RATs have higher (or lower) priority than other RATs, and accordingly are searched before (or after) other possible RATs supported by the wireless device. For example, if a RAT is more time consuming or otherwise less desirable to search, it maybe preferable to wait until other bands/RATs have been searched before attempting to search that RAT, since in case all target PLMNs have been found from higher priority RATs, it may be possible to provide complete search results without needing to search that RAT at all.

The techniques described herein may be implemented in and/or used with a number of different types of devices, including but not limited to cellular phones, tablet computers, wearable computing devices, portable media players, cellular network infrastructure equipment, servers, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings, in which:

FIG. 1 illustrates an exemplary (and simplified) wireless communication system;

FIG. 2 illustrates a base station (BS) in communication with a user equipment (UE) device;

FIG. 3 illustrates an exemplary block diagram of a UE;

FIG. 4 illustrates an exemplary block diagram of a BS;

FIG. 5 illustrates an exemplary block diagram of a server computer system;

FIG. 6 is a flowchart diagram illustrating an exemplary method for performing a targeted PLMN search; and

FIGS. 7-9 are flowchart diagrams illustrating possible exemplary further details of the method of FIG. 6.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

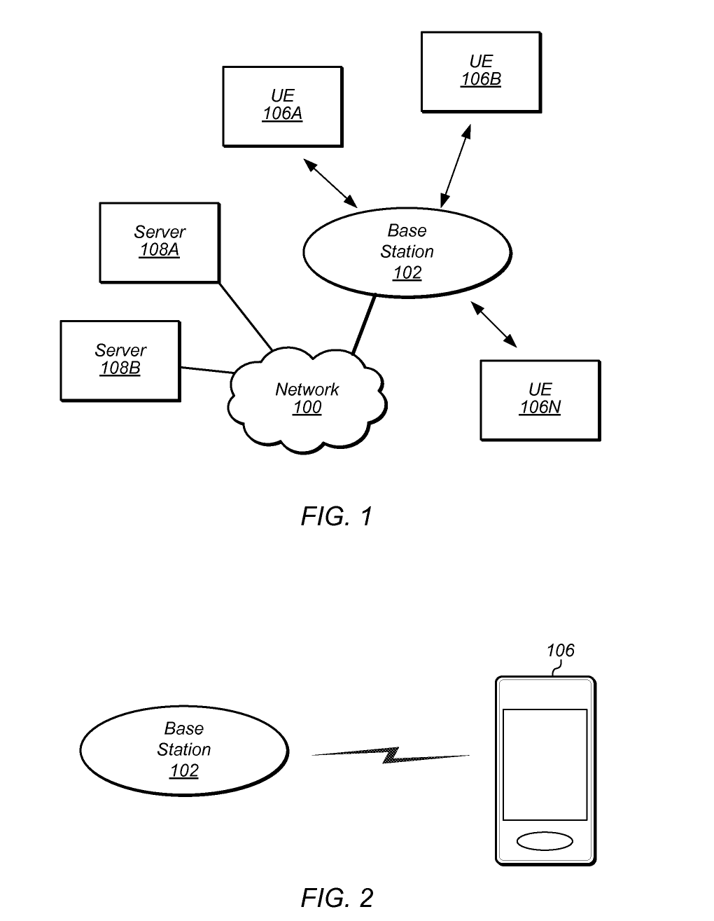

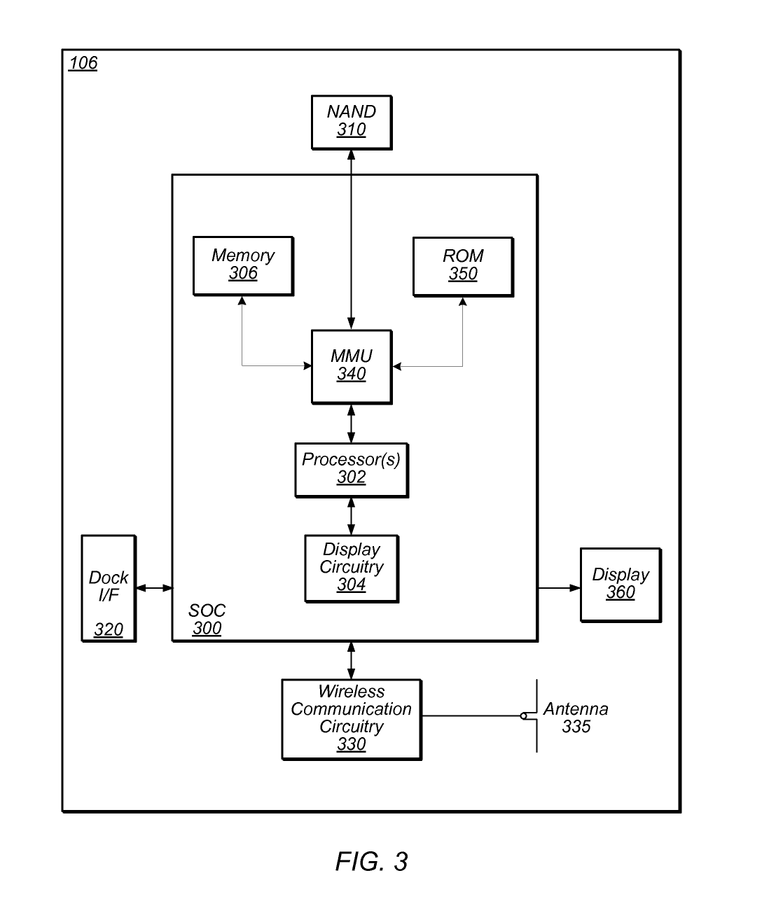

### FIGS. 1 and 2—Communication System

FIG. 1 illustrates an exemplary (and simplified) wireless communication system. It is noted that the system of FIG. 1 is merely one example of a possible system, and embodiments of the disclosure may be implemented in any of various systems, as desired.

As shown, the exemplary wireless communication system includes a base station 102 which communicates over a transmission medium with one or more user devices 106A, 106B, etc., through 106N. Each of the user devices may be referred to herein as a “user equipment” (UE). Thus, the user devices 106 are referred to as UEs or UE devices.

The base station 102 may be a base transceiver station (BTS) or cell site, and may include hardware that enables wireless communication with the UEs 106A through 106N. If the base station 102 is implemented in the context of LTE, it may alternately be referred to as an ‘eNodeB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication between the user devices and/or between the user devices and the network 100.

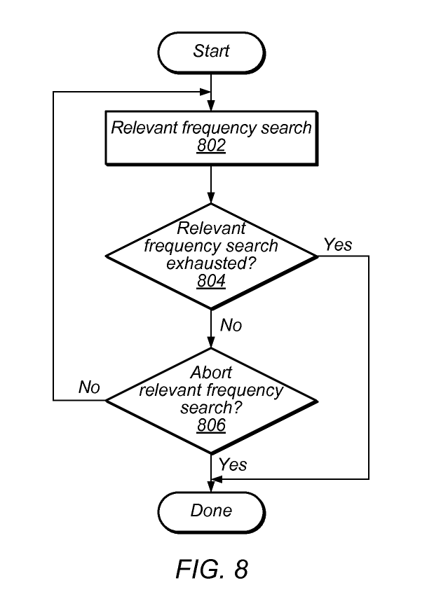

The network 100 may provide a communication link with one or more servers 108 (e.g., server 108A, server 108B) to the UEs 106 (e.g., by way of base station 102). The servers 108 (individually or collectively) may provide any of a variety of services to the UEs 106. For example, a server 108 might provide a database including any of various types of information which a UE 106 may query to access the information, a cloud based service such as a media streaming service, an intelligent personal assistant service, or a mapping service, an email server, or any of various other functions. As one specific possibility, a server 108 may store a cellular database including information regarding public land mobile networks (PLMNs), mobile country codes, etc. deployed in various regions, such as further described herein with respect to, inter alia, FIG. 6.

Note that while a communication link between the UEs 106 and the servers 108 by way of the base station 102 and the network 100 represents one possible such communication link, it may also or alternatively be possible to provide such a link by other means. For example, the UEs 106 might be capable of communicating with one or more Wi-Fi access points which provide access to the network 100 or another network which is communicatively coupled to one or more of the servers 108. Additionally, one or more intermediary devices or networks in addition to or as alternatives to those shown may be part of the communication link, if desired.

The communication area (or coverage area) of the base station may be referred to as a “cell.” The base station 102 and the UEs 106 may be configured to communicate over the transmission medium using any of various radio access technologies (RATs), wireless communication technologies, or telecommunication standards, such as GSM, UMTS (WCDMA, TD-SCDMA), LTE, LTE-Advanced (LTE-A), 3GPP2 CDMA2000 (e.g., 1xRTT, 1xEV-DO, HRPD, eHRPD), Wi-Fi, WiMAX etc.

Base station 102 and other similar base stations operating according to the same or a different cellular communication standard may thus be provided as a network of cells, which may provide continuous or nearly continuous overlapping service to UEs 106A-N and similar devices over a wide geographic area via one or more cellular communication standards.

Thus, while base station 102 may act as a “serving cell” for UEs 106A-N as illustrated in FIG. 1, each UE 106 may also be capable of receiving signals from (and possibly within communication range of) one or more other cells (which might be provided by other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. Other configurations are also possible.

Note that a UE 106 may be capable of communicating using multiple wireless communication standards. For example, a UE 106 might be configured to communicate using two or more of GSM, UMTS, CDMA2000, WiMAX, LTE, LTE-A, WLAN, Bluetooth, one or more global navigational satellite systems (GNSS, e.g., GPS or GLONASS), one and/or more mobile television broadcasting standards (e.g., ATSC-M/H or DVB-H), etc. Other combinations of wireless communication standards (including more than two wireless communication standards) are also possible.

FIG. 2 illustrates user equipment 106 (e.g., one of the devices 106A through 106N) in communication with a base station 102. The UE 106 may be a device with cellular communication capability such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

In some embodiments, the UE 106 may be configured to communicate using any of multiple RATs. For example, the UE 106 may be configured to communicate using two or more of GSM, UMTS, CDMA2000, LTE, LTE-A, WLAN, or GNSS. Other combinations of wireless communication technologies are also possible.

The UE 106 may include one or more antennas for communicating using one or more wireless communication protocols or technologies. In one embodiment, the UE 106 might be configured to communicate using either of CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 1xRTT (or LTE or GSM), and separate radios for communicating using each of Wi-Fi and Bluetooth. Other configurations are also possible.

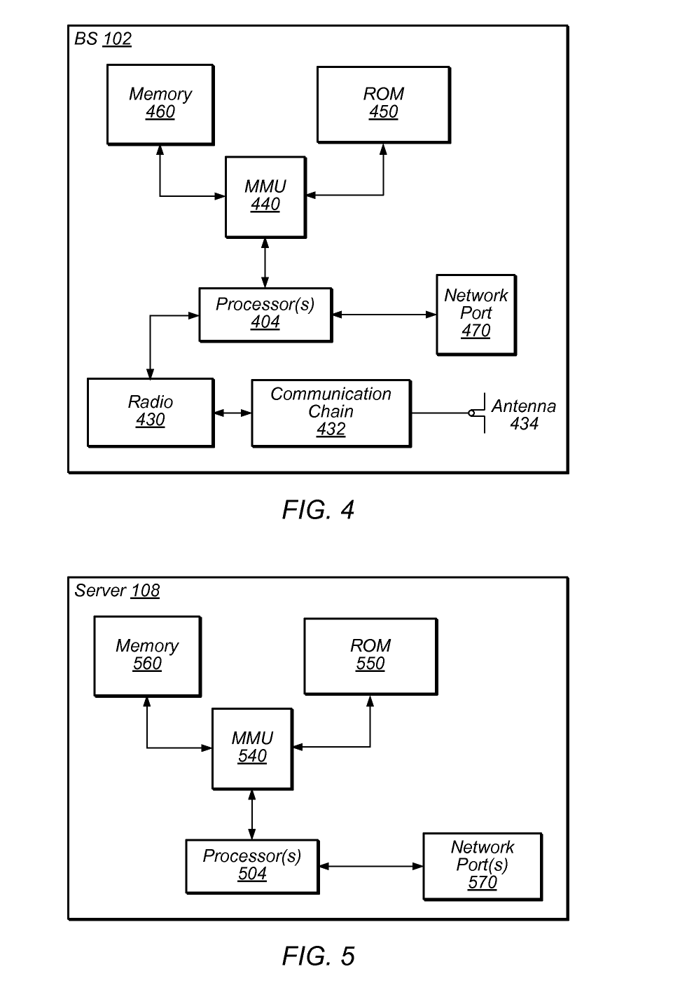

### FIG. 3—Exemplary Block Diagram of a UE

FIG. 3 illustrates an exemplary block diagram of a UE 106. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry (e.g., radio) 330 (e.g., for LTE, Wi-Fi, GPS, etc.).

The UE device 106 may include at least one antenna, and in some embodiments multiple antennas, for performing wireless communication with base stations and/or other devices. For example, the UE device 106 may use antenna 335 to perform the wireless communication. As noted above, the UE 106 may be configured to communicate wirelessly using multiple wireless communication standards in some embodiments.

As described further subsequently herein, the UE 106 may include hardware and software components for implementing features for performing a targeted PLMN search, such as those described herein with reference to, inter alia, FIG. 6. The processor 302 of the UE device 106 may be configured to implement part or all of the methods described herein, e.g., by executing program instructions stored on a memory medium (e.g., a non-transitory computer-readable memory medium). In other embodiments, processor 302 may be configured as a programmable hardware element, such as an FPGA (Field Programmable Gate Array), or as an ASIC (Application Specific Integrated Circuit). Alternatively (or in addition) the processor 302 of the UE device 106, in conjunction with one or more of the other components 300, 304, 306, 310, 320, 330, 335, 340, 350, 360 may be configured to implement part or all of the features described herein, such as the features described herein with reference to, inter alia, FIG. 6.

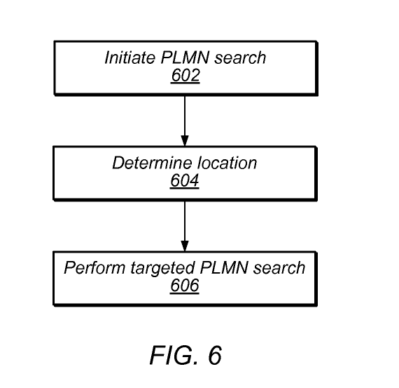

### FIG. 4—Exemplary Block Diagram of a Base Station

FIG. 4 illustrates an exemplary block diagram of a base station 102. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless telecommunication standards, including, but not limited to, LTE, LTE-A, UMTS, CDMA2000, Wi-Fi, etc.

The BS 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a Wi-Fi radio for performing communication according to Wi-Fi. In such a case, the base station 102 may be capable of operating as both an LTE base station and a Wi-Fi access point. As another possibility, the base station 102 may include a multi-mode radio which is capable of performing communications according to any of multiple wireless communication technologies (e.g., LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

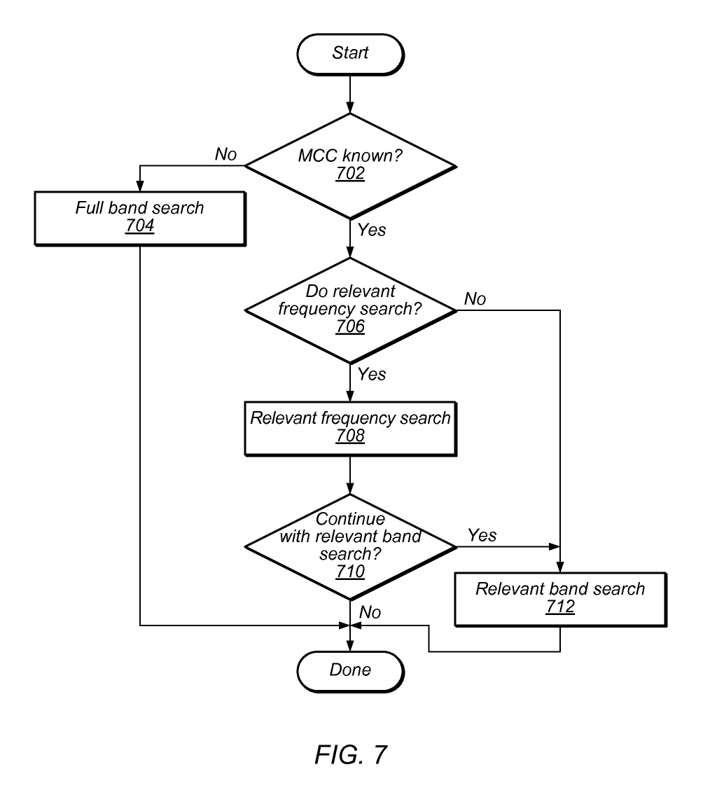

### FIG. 5—Exemplary Block Diagram of a Server

FIG. 5 illustrates an exemplary block diagram of a server computer 108. It is noted that the server of FIG. 5 is merely one example of a possible server 108. As shown, the server 108 may include processor(s) 504 which may execute program instructions for the server 108. The processor(s) 504 may also be coupled to memory management unit (MMU) 540, which may be configured to receive addresses from the processor(s) 504 and translate those addresses to locations in memory (e.g., memory 560 and read only memory (ROM) 550) or to other circuits or devices.

The server 108 may include at least one network port 570. The network port(s) 570 may include wired and/or wireless ports, and may be configured to couple to any of various networks and/or network elements, including one or more local networks, intranets, cellular core networks, public switched telephone networks, and/or the Internet, among various possibilities.

The server 108 may include hardware and software components for implementing features supporting targeted PLMN searching by a wireless user equipment device (such as UE 106 illustrated in FIGS. 1-3), such as those described herein with reference to, inter alia, FIG. 6. The processor 504 of the server 108 may be configured to implement or support implementation of part or all of the methods described herein, e.g., by executing program instructions stored on a memory medium (e.g., a non-transitory computer-readable memory medium). Alternatively, the processor 504 may be configured as a programmable hardware element, such as an FPGA (Field Programmable Gate Array), or as an ASIC (Application Specific Integrated Circuit), or a combination thereof. Alternatively (or in addition) the processor 504 of the server 108, in conjunction with one or more of the other components 540, 550, 560, 570 may be configured to implement or support implementation of part or all of the features described herein, such as the features described herein with reference to, inter alia, FIG. 6.

### FIG. 6—Flowchart Diagram

As the number of RATs and frequency bands used for wireless communication according to those RATs increases, the challenge of performing efficient and effective RAT and band scans at a wireless device has also increased. The long delays which may result from performing a comprehensive scan (e.g., a scan covering all bands and RATs which the device may be capable of scanning) may result in a negative user experience. However, absent any guiding methodology, limiting scanning breadth may result in incomplete results, which may in turn negatively affect subsequent device performance (e.g., if a device attaches to a sub-optimal network as a result of the incomplete results).

A targeted scan which narrows the search field in a manner that nonetheless results in identification of all relevant PLMNs may result in a shorter search time and consume less power than a comprehensive scan, while still providing complete results.

FIG. 6 is a flowchart diagram illustrating such a method for performing a targeted PLMN search. The method shown in FIG. 6 may be used in conjunction with any of the computer systems or devices shown in the above Figures, among other devices. In various embodiments, some of the elements of the method shown may be performed concurrently, in a different order than shown, or may be omitted. Additional elements may also be performed as desired. As shown, the method may operate as follows.

In 602, a PLMN search may be initiated at a UE. The PLMN search may be any of a variety of types of PLMN searches. As one possibility, the PLMN search may be a manual PLMN search, i.e., a PLMN search initiated by a user of the UE. In such a case, the PLMN search may be initiated based on user input initiating the manual PLMN search. Alternatively, the PLMN search may be an automatic background PLMN search (such as might be undertaken by a UE as part of normal cellular operation) or foreground PLMN search (such as might be undertaken by a UE while out of service (OOS) or after being powered on), or any other type of PLMN search.

A comprehensive or full PLMN search might include searching (scanning frequency bands) for PLMNs using each of multiple RATs according to which the UE may be capable of operating, in each of multiple possible frequency bands for each RAT. For example, a 3GPP compliant UE might be capable of communicating using any or all of GSM (e.g., in 900 MHz, 1800 MHz, 850 MHz, 1900 MHz, and/or other frequency bands), WCDMA (e.g., in band I, II, III, V, VIII, and/or other frequency bands), TD-SCDMA (e.g., in band A, band F, and/or other frequency bands), or LTE (e.g., in band 1, 2, 3, 4, 5, 7, 8, 13, 17, 25, 26, 38, 39, and/or other frequency bands). Alternatively (or in addition) a 3GPP2 compliant UE might be capable of communicating using any or all of cdmaOne or CDMA2000, in any of various associated frequency bands. Thus, a UE may generate and/or store a set or list of RATs and frequency bands which the UE is capable of searching for PLMNs.

In 604, the UE may attempt to determine its location, or more generally location information associated with the location of the UE. The location of the UE may be determined in any of a variety of ways. As one possibility, the UE may determine its location based on a serving cell of the UE. For example, if the UE already has obtained cellular service (e.g., if the PLMN search is a background search or manual PLMN search), the UE may already know the mobile country code (MCC) of the serving cell of the UE (e.g., from a system information block (SIB) broadcast by the serving cell). Alternatively, the UE may determine the MCC associated with its location from a (non-serving) cell detected by the UE, e.g., similarly from a SIB broadcast by the cell. As further possibilities, the UE may determine its location based on global navigational satellite system (GNSS) based location information, terrestrial broadcast information (e.g., FM radio broadcast, television broadcast, etc.) Wi-Fi based information (e.g., information provided in a Wi-Fi beacon from a nearby Wi-Fi access point), information obtained via Bluetooth communication, and/or any other information.

In some instances, location information initially obtained by the UE may be translated into a format which may be used by the UE to generate or obtain PLMN search targeting information. For example, a UE might determine from a Wi-Fi beacon or terrestrial broadcast a name of a country in which the UE is located, and may translate that information into a MCC associated with that country. As another possibility, a UE might determine from a GNSS module in the UE geographical coordinates of the UE, and may translate that information into a MCC associated with that location. In some instances, such translation or correspondence information may be stored in a database (which may be internal or external to the UE itself) which correlates one or more types of location information (e.g., country name, geospatial coordinates/polygons, etc.) with one or more MCCs. Note that at least in some instances, multiple MCCs may be associated with a location. For example, near a border between countries, PLMNs operating in each of the nearby countries may be available, so MCCs associated with each of the nearby countries may be correlated with locations in that border region, if desired.

Based on the location information (e.g., one or more MCCs associated with the location of the UE), further PLMN search targeting information may be obtained (e.g., from an external source such as a server) and/or determined (e.g., from internally stored information). As a possible example, the UE might determine a set of carriers or PLMNs associated with the UE's current MCC(s) and/or frequencies/frequency ranges used (deployed) by those carriers/PLMNs. As another possible example, the UE might determine a set of RATs and/or frequency bands used (deployed) in the UE's current MCC(s). Based on such information, the UE may determine (e.g., generate a list of) a ‘relevant’ subset of all of the possible RATs and frequency bands which the UE would be capable of scanning

In 606, the UE may perform the PLMN search in a targeted manner. For example, the UE may not search for PLMNs on frequencies, frequency bands, or RATs which are not in the determined subset of RATs and bands. In other words, those RATs and/or frequency bands not associated with the UE's current MCC(s) may be excluded (at least initially) from the PLMN search (the number of frequencies, frequency bands, and/or RATs on which PLMNs are searched for may be reduced), such that the UE may search (at least initially) for PLMNs only in the determined subset of RATs and frequency bands.

In some instances, targeting the PLMN search may alternatively or additionally include terminating the PLMN search once all PLMNs associated with the UE's current MCC(s) have been found (identified and/or acquired), even if not all possible RATs and bands of the set (or even subset) of possible RATs and bands have been searched. For example, in some instances the UE may be able to determine that PLMNs corresponding to all carriers known in the UE's current MCC(s) have been acquired, and abort or terminate further searching in response to this.

Additionally, in some instances targeting the PLMN search may include determining a preferred search order. The preferred search order may prioritize the RATs to be searched (and possibly also the frequencies and/or frequency bands). For example, in a 3GPP compliant UE, GSM searching may be de-prioritized (e.g., since it is a narrow band system, may be more time consuming, and/or because it may be an older RAT). In general, any of various optimization algorithms and preferences may be used to generate or determine the preferred search order, as desired.

As previously noted, various information used in the method of FIG. 6 may be obtained from sources external to the UE. For example, as one possibility PLMN search targeting information may be obtained from a cellular database hosted on a server external to the UE, such as a server 108 illustrated in FIG. 1. The cellular database may, for example, include information indicating which PLMN(s), RAT(s), band(s), and/or frequency(s) are relevant for each MCC of some or all MCCs across the world, and may provide such information to permitted UEs upon request. The UE may thus obtain such PLMN search targeting information by providing a query to such a server indicating its current MCC(s), and receiving a reply from the server including the requested PLMN search targeting information.

Note that as another possibility, the UE may maintain a local copy of such a cellular database. In this case, the UE may still (at least in some instances) receive updates (e.g., over-the-air updates) to its local cellular database from an external server/cellular database, e.g., in order to ensure its information remains up-to-date. Such updates may be provided on a push basis (e.g., from the server to the UE at the server's discretion), on a pull basis (e.g., from the server to the UE upon request from the UE to the server), or both, among possible ways of keeping a local copy of the cellular database up-to-date.

Note also that such a server may itself obtain such information and maintain the cellular database in any of a variety of ways. As one possibility, the server may (occasionally or regularly) poll various carriers operating in various parts of the world for information regarding their PLMN(s), RAT(s), band(s), and/or frequency(s). As another (alternate or additional) possibility, the server may obtain such information by harvesting crowd-sourced information, for example by (occasionally or regularly) tasking and/or polling various UEs operating in various parts of the world to obtain information regarding PLMN(s), RAT(s), band(s), and/or frequency(s) deployed in various locations. For example, a device vendor (such as a vendor of the UE implementing the method of FIG. 6) might provide and maintain such a cellular database by obtaining such crowd-sourced information from UEs sold by the device vendor, and also provide access to the cellular database and/or updates for local cellular databases to those UEs in order to facilitate targeted PLMN searching by those UEs. As another example, a software vendor (such as a vendor of an operating system of the UE) might provide and maintain such a cellular database by obtaining such crowd-sourced information from UEs which execute software provided by the software vendor, and also provide access to the cellular database and/or updates for local cellular databases to those UEs in order to facilitate targeted PLMN searching by those UEs.

Based on the targeted PLMN search, the UE may select a PLMN to which to attach or establish a wireless communication link. If the PLMN search is an automatic PLMN search, the PLMN selected may be chosen based on internal PLMN priority considerations (e.g., may be a ‘high priority’ PLMN), for example based on the UE's carrier, subscription agreement, and/or any roaming agreements between that carrier and other carriers, among various possible reasons. If the PLMN search is a manual PLMN search, the UE may provide a user interface indicating results of the PLMN search (e.g., indicating identified/acquired PLMNs). User input selecting a PLMN from those indicated may then be received, that the UE may establish (or at least attempt to establish) the wireless communication link with the selected PLMN.

Note that at least in some instances (e.g., if the PLMN search is a background PLMN search), the UE may already have established a wireless communication link with a PLMN, and so may not select a PLMN to which to attach or establish a wireless communication link based on the targeted PLMN search.

Note further that while the method of FIG. 6 describes steps for performing a targeted PLMN search on a single instance, the method may be expanded and/or repeated as desired. For example, if a UE enters a new region (e.g., country) and a PLMN search is initiated, the UE may repeat part or all of the method of FIG. 6 to perform a targeted PLMN search in the new region.

It should also be noted that that in some instances, the UE may implement a fall-back mechanism, whereby if any single targeting aspect of a targeted PLMN search is not possible at a given time (e.g., due to unavailability of information needed to implement that mechanism), other aspects may still be used, and whereby if all targeting aspects of the targeted PLMN search are not possible at a given time, the UE may still be able to perform a full (all-band, all-RAT) scan. Additionally, it should be noted that while all of the various aspects of a targeted PLMN search described herein with respect to FIG. 6 may be used together if desired, it may also be possible to implement only selected targeting aspects of those described herein to perform a targeted PLMN search.

It should still further be noted that a given UE may perform a targeted PLMN search using different techniques in different instances of implementing the method of FIG. 6 (e.g., as a result of different fall-back scenarios occurring at the different instances); for example, a UE might obtain frequency band and RAT deployment information but not a list of target PLMNs for a MCC in one instance, and obtain a list of target PLMNs but not frequency band and RAT deployment information for a MCC in another instance.

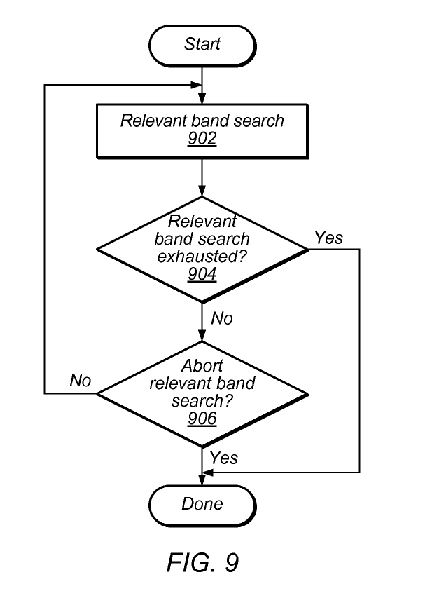

### FIGS. 7-9—Additional Flowchart Diagrams

FIGS. 7-9 are flowchart diagrams illustrating further possible details according to which the method of FIG. 6 may be implemented, if desired. It should be noted, however, that the exemplary details illustrated in and described with respect to FIGS. 7-9 are not intended to be limiting to the disclosure as a whole: numerous variations and alternatives to the details provided herein below are possible and should be considered within the scope of the disclosure.

The methods shown in FIGS. 7-9 may be used in conjunction with any of the computer systems or devices shown in the above Figures, among other devices. In various embodiments, some of the elements of the method shown may be performed concurrently, in a different order than shown, or may be omitted. Additional elements may also be performed as desired. As shown, the methods may operate as follows.

A PLMN search may be initiated at a UE. The PLMN search may be a manual PLMN search, or a foreground or background PLMN search if desired.

In 702, it may be determined if the MCC (or MCCs, e.g., if in a border region) of the UE is known. This step may be implemented by a ‘MCC Known’ function block, which may be capable of obtaining MCC info by cellular communication means (e.g., by way of a serving or detected cell from a 3GPP or 3GPP2 system), or by any of various non-cellular sources, such as GPS, Wi-Fi, Bluetooth, FM, etc.

If the MCC is not known, in 704 the UE may perform the PLMN search as an all-band, all-RAT search. In other words, the UE may search for PLMNs using all possible RATs according to which it is configured to communicate, in all possible frequency bands for each RAT. Once the all-band, all-RAT search is complete, the PLMN search may be complete.

If the MCC is known, in 706 it may be determined whether or not to employ a ‘relevant frequency search’ type PLMN search targeting strategy. Such a decision may be made by a ‘Do Relevant Frequency Search’ function block, which may determine whether MCC specific frequency info is available for the known MCC(s). The MCC specific frequency info may include information specifying which frequencies are used by carriers operating in that MCC for any or all RATs deployed in that MCC.

If MCC specific frequency info is available for the known MCC(s), in 708 a relevant frequency search may be performed. This may include searching for and attempting to identify any PLMNs operating in frequencies which have been determined to be relevant based on the MCC(s) of the UE.

If desired, the relevant frequency search step performed in step 708 may also provide the capability for early termination or abortion of the relevant frequency search. FIG. 8 illustrates a possible subprocess of a relevant frequency search with such early termination capability.

As shown in FIG. 8, in such a scenario when it is determined to deploy a relevant frequency search, in 802 a frequency (or frequency range) determined to be relevant may be searched (scanned) to determine whether any PLMNs are present (deployed) on that frequency according to a particular RAT (or possibly according to any of multiple possible RATs).

After searching that frequency, in 804 it may be determined whether or not the relevant frequency search is exhausted. The relevant frequency search may be exhausted when no more potentially relevant frequencies (e.g., based on the MCC(s)) remain to be searched.

If there remain potentially relevant frequencies, the subprocess may proceed to step 806, in which it may be determined whether or not to abort the relevant frequency search. The relevant frequency search may be aborted if the UE is able to determine which PLMNs it is searching for (e.g., based on knowing the MCC(s) for its location), and if all of those PLMNs have already been identified/acquired, even if there are further potentially relevant frequencies which have not yet been searched.

If it is determined not to abort the relevant frequency search early (e.g., if there remain target PLMNs which have not yet been found and potentially relevant frequencies which have not yet been searched), the subprocess may return to step 802 and continue searching another potentially relevant frequency.

In case all targeted PLMNs have been found, and/or all relevant frequencies have been searched, the relevant frequency search subprocess may be complete.

Proceeding then from step 708 in FIG. 7 once the relevant frequency search is complete, in 710 it may be determined whether or not to continue and also perform a relevant band search. If all targeted PLMNs have been found based on the relevant frequency search, it may be unnecessary to further perform a (e.g., more broad) relevant band search. In this case the PLMN search process may be complete.

However, if not all targeted PLMNs were found based on the relevant frequency search, in 712 a relevant band search may be performed. Note that it may also be desirable to perform a relevant band search if it is determined not to perform a relevant frequency search (e.g., if relevant frequency information for the MCC is not available but relevant band information for the MCC is available), for example proceeding to step 712 from decision 706 in the ‘no’ scenario.

The relevant band search may include searching for and attempting to identify any PLMNs operating in frequency bands which are determined to be relevant based on the MCC(s) of the UE; for example, certain countries may utilize only a portion of possible frequency bands for certain RATs, due to regulatory or various other reasons.

If desired, the relevant band search step performed in step 712 may also provide the capability for early termination or abortion of the relevant band search. FIG. 9 illustrates a possible subprocess of a relevant band search with such early termination capability.

As shown in FIG. 9, in such a scenario when it is determined to deploy a relevant band search, in 902 a frequency band determined to be relevant may be searched (scanned) to determine whether any PLMNs are present (deployed) on any frequency channels in that frequency band according to a particular RAT (or possibly according to any of multiple possible RATs).

After searching that frequency band, in 904 it may be determined whether or not the relevant band search is exhausted. The relevant band search may be exhausted when no more potentially relevant frequency bands (e.g., based on the MCC(s)) remain to be searched.

If there remain potentially relevant bands, the subprocess may proceed to step 906, in which it may be determined whether or not to abort the relevant band search. The relevant band search may be aborted if the UE is able to determine which PLMNs it is searching for (e.g., based on knowing the MCC(s) for its location), and if all of those PLMNs have already been identified/acquired, even if there are further potentially relevant frequency bands which have not yet been searched.

If it is determined not to abort the relevant band search early (e.g., if there remain target PLMNs which have not yet been found and potentially relevant bands which have not yet been searched), the subprocess may return to step 802 and continue searching another potentially relevant frequency band.

In case all targeted PLMNs have been found, and/or all relevant bands have been searched, the relevant band search subprocess may be complete.

Proceeding then from step 712 in FIG. 7 once the relevant band search is complete, if all targeted PLMNs have been found, the PLMN search process may be complete. Not that although not shown in FIG. 7, it may be possible to configure a UE to proceed further to step 704 to perform a full band search (or possibly the remainder of a full band search, e.g., excluding any band/RAT combinations already searched) if not all target PLMNs have been found even after performing a relevant band search, if desired. Alternatively, a UE may be configured to consider the PLMN search process complete after performing the relevant band search regardless of whether or not all targeted PLMNs have been found.

As a further possibility, in some instances if the MCC(s) is (are) known but there is neither MCC specific frequency information nor MCC specific band information, and thus the UE is unable to perform either a targeted relevant frequency search or a relevant band search, the UE may also be configured to fall back to step 704 to perform a full band search. Once the full band search is complete, the PLMN search process may be complete.

Note that the particular techniques employed to search for PLMNs (e.g., as part of relevant frequency search(es), relevant band search(es), and/or full band search(es)) may be any of various possible techniques. As one example, a frequency may first be scanned for signal strength, power spectrum density profile (PSD), bandwidth, and/or other characteristics. If the characteristics are determined to indicate that cellular communication may be present on the frequency, an attempt may be made to acquire/identify the system (e.g., PLMN) deployed at that frequency (e.g., by decoding broadcast information such as a system information block (SIB)). Other techniques (which may depend on the RAT according to which the search is being performed) are also possible.

Embodiments of the present disclosure may be realized in any of various forms. For example some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A wireless user equipment (UE) device, comprising:
a radio; and
a processing element operably coupled to the radio,
wherein the radio and the processing element are configured to:
initiate a public land mobile network (PLMN) search;
determine one or more mobile country codes (MCCs) corresponding to a current location of the UE;
determine one or more frequencies, frequency bands, or radio access technologies (RATs) associated with the one or more MCCs; and
perform a targeted PLMN search on the determined one or more frequencies, frequency bands, or RATs associated with the one or more MCCs.

2. The UE of claim 1,
wherein the targeted PLMN search excludes searching for PLMNs on one or more frequencies, frequency bands, or RATs not associated with the one or more MCCs.

3. The UE of claim 1, wherein the radio and the processing element are further configured to:
determine one or more PLMNs associated with the one or more MCCs;
identify the one or more PLMNs associated with the one or more MCCs during the targeted PLMN search; and
terminate the targeted PLMN search after identifying the one or more PLMNs associated with the one or more MCCs are identified.

4. The UE of claim 3,
wherein terminating the targeted PLMN search after identifying the one or more PLMNs associated with the one or more MCCs are identified prevents the UE from further searching on the determined one or more frequencies, frequency bands, or RATs.

5. The UE of claim 1, wherein the radio and the processing element are further configured to:
determine a preferred search order in which to perform the targeted PLMN search, wherein the preferred search order prioritizes the determined one or more frequencies, frequency bands, or RATs, wherein the radio and the processing element are further configured to perform the targeted PLMN search according to the preferred search order.

6. The UE of claim 1, wherein the radio and the processing element are further configured to:
obtain information indicating that the one or more frequencies, frequency bands, or RATs associated with the one or more MCCs are associated with the one or more MCCs from a server.

7. The UE of claim 1, wherein the radio and the processing element are configured to determine the one or more MCCs corresponding to the current location of the UE based on one or more of:
a serving cell of the UE;
a cell detected by the UE;
global navigational satellite system (GNSS) based location information;
terrestrial broadcast information;
a Wi-Fi beacon;
a database local or external to the UE comprising information correlating one or more types of location information with one or more MCCs.

8. The UE of claim 1, wherein the PLMN search comprises one of:
a manual PLMN search;
a background PLMN search; or
a foreground PLMN search.

9. A non-transitory computer accessible memory medium comprising program instructions which, when executed at a wireless user equipment (UE) device, cause the UE to:
determine a set of radio access technologies (RATs) and frequency bands which the UE is capable of searching for public land mobile networks (PLMNs);
determine a location of the UE;
determine a set of PLMNs associated with the location;
search the set of RATs and frequency bands for the determined set of PLMNs; and
abort further search after identifying all PLMNs in the determined set of PLMNs.

10. The memory medium of claim 9, wherein when executed the program instructions further cause the UE to:
determine a subset of the set of RATs and frequency bands based at least in part on the location of the UE and the set of PLMNs associated with the location,
wherein searching the set of RATs and frequency bands for the determined set of PLMNs excludes searching RATs and frequency bands not in the determined subset.

11. The memory medium of claim 9, wherein the PLMN search comprises a manual PLMN search, wherein when executed the program instructions further cause the UE to:
receive user input initiating the manual PLMN search;
provide a user interface indicating results of the manual PLMN search;
receive user input selecting a PLMN; and
establish a wireless communication link with the selected PLMN.

12. The memory medium of claim 9, wherein when executed the program instructions further cause the UE to:
determine a preferred RAT search order,
wherein searching the set of RATs and frequency bands for the determined set of PLMNs comprises searching in the preferred RAT search order.

13. A method for operating a wireless user equipment (UE) device, the method comprising:
initiating a public land mobile network (PLMN) search;
determining whether PLMN search targeting information is available; and
performing a targeted PLMN search if PLMN search targeting information is available,
wherein performing the targeted PLMN search comprises reducing a number of frequencies, frequency bands, and/or radio access technologies (RATs) on which PLMNs are searched for based on the PLMN search targeting information.

14. The method of claim 13,
wherein the PLMN search targeting information is location related.

15. The method of claim 13,
wherein the PLMN search targeting information comprises one or more mobile country codes (MCCs) corresponding to a location of the UE.

16. The method of claim 15, wherein the PLMN search targeting information further comprises information regarding one or more of:
carriers known to operate in countries represented by the one or more MCCs;
frequencies deployed by carriers known to operate in countries represented by the one or more MCCs;
RATs known to be deployed in countries represented by the one or more MCCs;
frequency bands known to be deployed in countries represented by the one or more MCCs.

17. The method of claim 13,
wherein performing the targeted PLMN search comprises searching only frequencies, frequency bands, and/or RATs known to be deployed in countries represented by the one or more MCCs.

18. The method of claim 13,
wherein performing the targeted PLMN search further comprises:
determining that PLMNs corresponding to all carriers known to operate in countries represented by the one or more MCCs have been acquired; and
aborting further search based on said determining.

19. The method of claim 13, the method further comprising:
receiving the PLMN search targeting information from a server.

20. The method of claim 19,
wherein the PLMN search targeting information is generated by the server based on crowd-sourced information harvesting.
